(19) United States
(12) Patent Application Publication
(10) Pub. No.: US 2026/0218850 A1
(43) Pub. Date: Jul. 30, 2026

(54) HEAVY-DUTY ZINC CUT-IN MOUNTING BRACKET

(71) Applicant: Arlington Industries, Inc., scranton, PA (US)

(72) Inventor: THOMAS J. GRETZ, DELRAY BEACH, FL (US)

(73) Assignee: Arlington Industries, Inc., scranton, PA (US)

(21) Appl. No.: 19/630,241

(22) Filed: Mar. 26, 2026

Related U.S. Application Data
(60) Provisional application No. 63/750,395, filed on Jan. 28, 2025.

(51) Int. Cl. F16M 13/02

(52) U.S. Cl. CPC F16M 13/02

(57) ABSTRACT

A heavy-duty cut-in mounting bracket for low voltage Class 2 wiring in commercial construction. The bracket includes a heavy-duty die-cast frame with an integral flange and mounting wing screws to hold the bracket secure and flush with the wall when the mounting screws are tightened. Wings are mounted on the end of the captive mounting screws. The captive mounting screws can be rotated to a counterclockwise configuration wherein the wings will be positioned inside the frame or turned to a clockwise configuration to position the wings outside of the frame. In the counterclockwise configuration the bracket can be inserted within a wall opening. In the clockwise configuration the captive mounting screws can be fully tightened to draw the wings against the wall and secure it thereto.

This application claims the benefit of application 63750395, which was filed on 01/28/2025 and which is incorporated herein in its entirety.

### FIELD OF THE INVENTION

This invention relates to the mounting of low voltage wall plates and, more particularly, to a heavy-duty zinc cut-in bracket that offers extra rigidity than wall plates constructed of plastic or sheet metal.

### BACKGROUND OF THE INVENTION

Although various mounting brackets have been proposed for mounting low voltage electrical plates to walls, conventional mounting brackets are typically constructed of plastic or sheet metal, which lack sufficient rigidity to mount the bracket flush with the wall. Additionally, the conventional brackets typically are attached to the wall by screws through a flange of the bracket and tightening of the screws tend to cause the flange and other portions of the conventional mounting bracket to buckle or deform, thereby compromising the ability to provide a flush attachment of the wall plate to the wall.

### BRIEF SUMMARY OF THE INVENTION

The invention is a heavy-duty cut-in mounting bracket for low voltage Class 2 wiring in commercial construction. The bracket includes a heavy-duty die-cast frame with an integral flange and mounting wing screws to hold the bracket secure and flush with the wall when the mounting screws are tightened. Wings are mounted on the end of the captive mounting screws. The captive mounting screws can be rotated to a counterclockwise configuration wherein the wings will be positioned inside the frame or rotated in a clockwise configuration to position the wings outside of the frame. In the counterclockwise configuration the bracket can be inserted within a wall opening. In the clockwise configuration the captive mounting screws can be fully tightened to draw the wings against the wall and secure it thereto.

### BRIEF DESCRIPTION OF THE DRAWINGS

FIG. 1 is a front perspective view of the heavy-duty cut-in mounting bracket of the present invention.

FIG. 2 is a front elevation view of the cut-in mounting bracket.

FIG. 3 is a side view of the cut-in mounting bracket.

FIG. 4 is an end view of the cut-in mounting bracket.

FIG. 5 a rear elevation view of the cut-in mounting bracket.

FIG. 6 a front elevation view of a spacer according to the present invention.

FIG. 7 a side view of the spacer.

FIG. 8 is a detail view of a post portion of the spacer.

FIG. 9 is a front view depicting the joining of two cut-in mounting brackets to form a two-gang cut-in bracket.

### DETAILED DESCRIPTION OF THE INVENTION

Low voltage wall plates, which typically include one or more low voltage devices, such as for Class 2 communications, computer, and cable TV wiring are commonly mounted directly to walls.

Although various devices have been proposed for mounting of low voltage plates to walls, they are typically constructed of plastic or sheet metal and include low rigidity. When mounted to thin or weak walls, such as may be encountered in an old work situation or a new work situation with thin drywall the existing devices do not adequately support a low voltage device and plate.

Accordingly, there is still a need for providing a low voltage bracket that can be used to rapidly mount a wall plate flush to a wall.

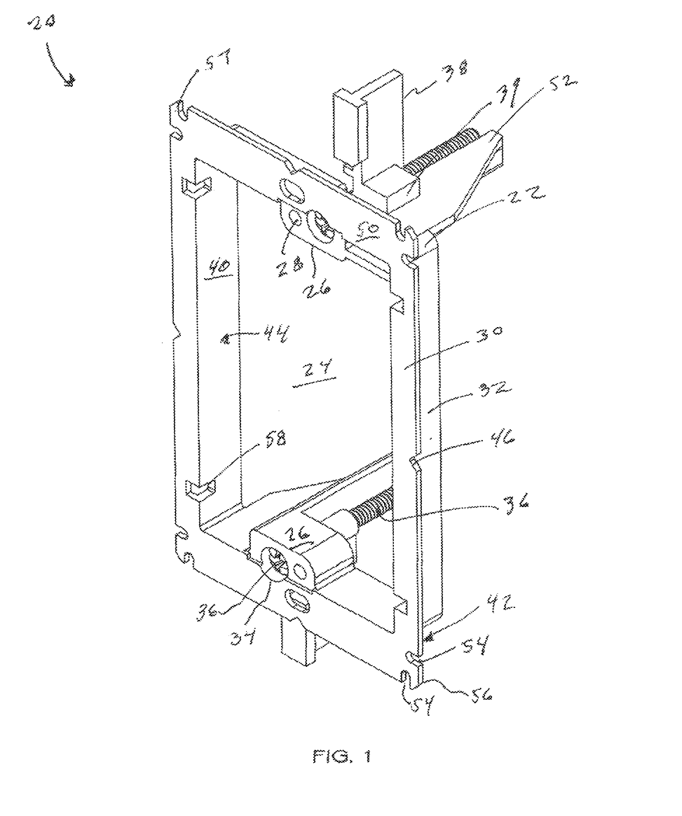

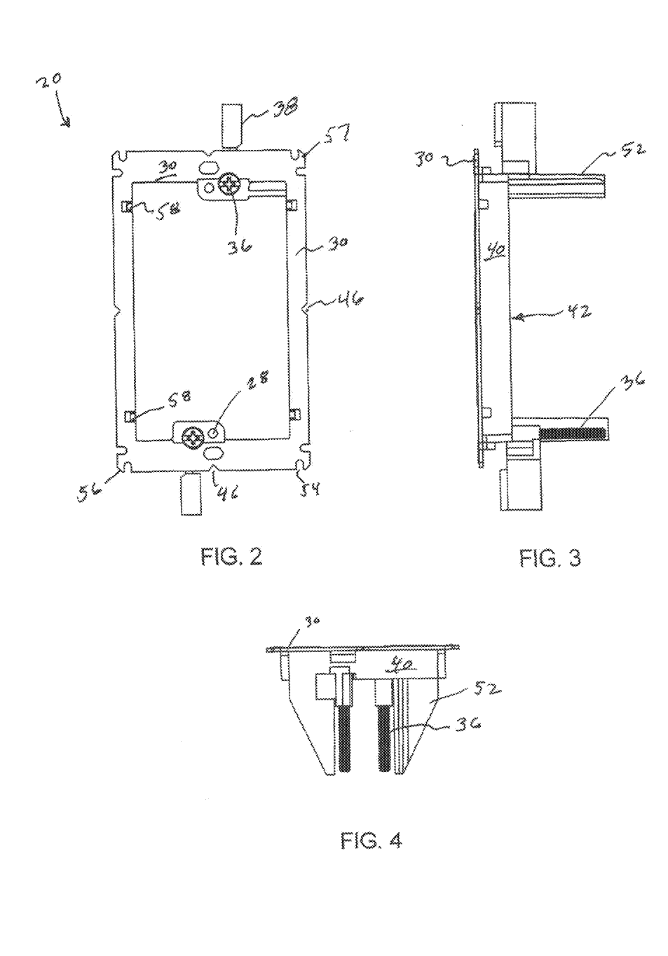

Referring to FIGS. 1-5, the heavy-duty cut-in mounting bracket 20 of the present invention has features that deliver a sturdier, more rigid, better-looking, and easy to install bracket. The bracket includes a rigid frame 22 defining an opening 24 with frame extensions 26 extending inwardly from the frame. The frame 22 is preferably a die-cast in one piece of zinc alloy. Threaded screw holes 28 are provided in the frame extensions 26. A first flange 30 extends outward from the outer periphery 32 of the frame. The rigid frame 22 of the cut-in mounting bracket 20, die-cast in one piece of zinc alloy, will retain its rigidity to mount wall plates flush with the wall. The single gang cut-in mounting bracket, offers extra rigidity for both new and old work situations, so it won’t bend as easily as plastic or sheet metal brackets.

The cut-in mounting bracket 20 has additional apertures 34 with captive mounting screws 36 positioned in the apertures 34 to enable easy and fast device installation, and labor savings. Wings 38 and tabs 39 on the ends of the captive mounting screws 36 enable rapid adjustment of the bracket 22 to fit wall board from 1/4" to 1" thick. Furthermore, the cut-in mounting bracket serves as the template for the cut out in the wall. The installer simply places the planar front side of the bracket against the wall in the desired location, levels the bracket, traces inside the bracket, and then cuts an opening with a hole saw or similar tool.

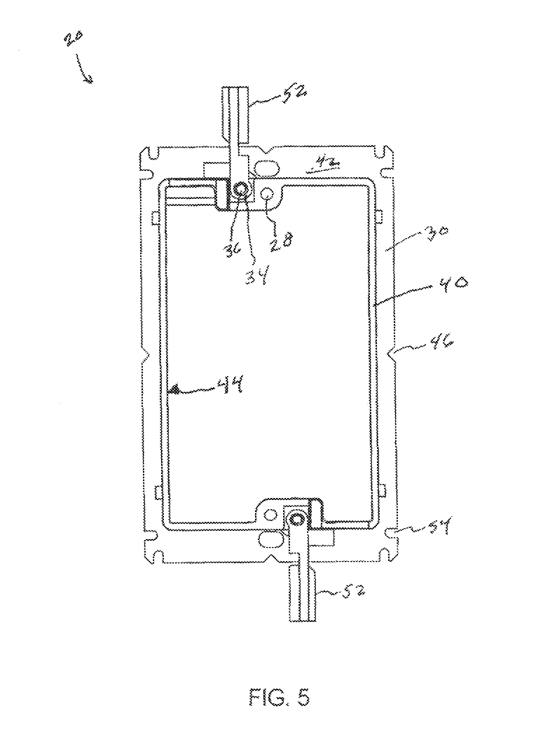

With reference to FIG. 5, a second flange 40 extends from the rear side 42 of the frame around the inner periphery 44 of the frame 22. The second flange 40 will extend through the drywall and will provide additional rigidity and bending resistance to the frame 22. Preferably the first flange 30 is at least 0.045 inch in thickness and the second flange 40 includes a thickness of at least 0.075 inch to provide a rigid frame 22, and the first flange 30 and the second flange 40 are perpendicular to one another to provide sufficient rigidity to resist flexing caused by non planar walls.

Referring to FIG. 1, V-shaped notches 46 are included on the outer periphery 32 of the frame 22. The V-shaped notches 46 enable marking of the wall to provide a reference of where to cut the wall. The V-shaped notches are aligned with the center of the opening 24. To mark the wall, the installer simply places the planar front side 50 of the bracket 20 against the wall in the desired location, levels the bracket, traces around the inside opening 24 of the bracket, and then cuts an opening with a hole saw or similar tool. Frame arms 52 are integral with and extend from the rear side 42 of the of the frame 22. U-shaped notches 54 are included near the corners 56 of the frame 22 and define end portions 57 thereon. After fitting the frame at the wall opening, upon clockwise rotation of the mounting screws 38, the tabs 39 will engage the frame arms 52 and cause the mounting screws to draw towards the wall and frame 22. Full tightening of the mounting screws will tightly secured the cut-in bracket 20 to the wall. The frame includes one or more slots 58 at the edge of the opening 24, with the slot extending through a portion of the first flange 30 and a portion of the second flange 40.

The specific steps for installing the bracket on a wall are as follows:
1) Level the bracket. Place the planar front side of the bracket flush on the wall surface;
2) Make a pencil ‘dot’ in all eight U-shaped notches in the corners;
3) Use the bracket as a straight edge to draw a cutting guideline between pencil marks;
4) Cut the wall opening along the guideline; and 5) Tighten the mounting screws to set the rear face of the second flange securely against the drywall.

The slots 58 are configured to accept insertion of the post 64 of a spacer 60 as described hereinbelow.

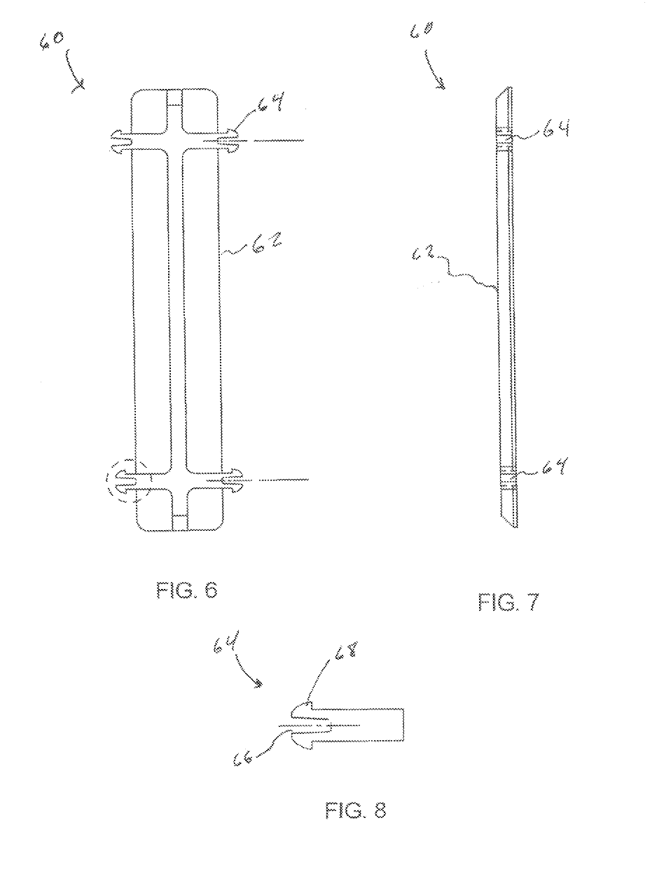

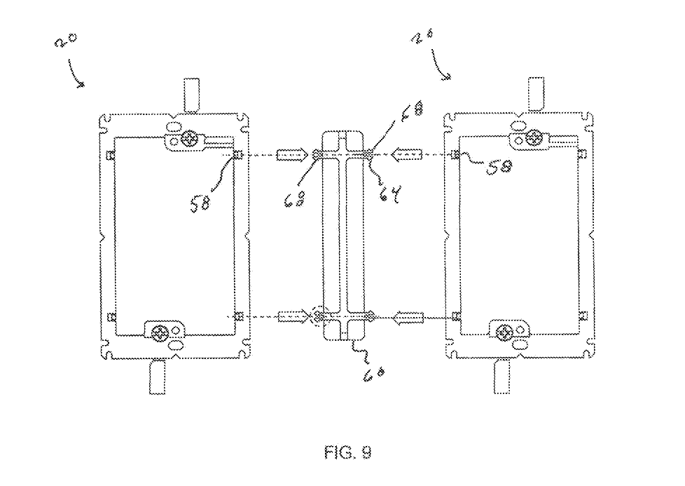

With reference to FIGS. 6-9, a spacer 60 for joining two adjacent brackets 20 includes a body 62 with a pair of posts 64 extending therefrom. As shown in FIG. 8, each post 64 includes bores 66 and end caps 68. As shown in FIG. 9, the end caps 68 collapse when pressed into the corresponding apertures 58 on the first flange 30 of the adjacent cut-in bracket 20. After clearing the first flange 30, the end caps 68 then expand outward and lock the joined cut-in brackets 20 together and forming a multi-gang bracket.

The cut-in mounting bracket is marked as “cULus listed", which is a certification mark issued by Underwriters Laboratories (UL), a global safety certification company, that indicates a product meets the safety standards of both the United States and Canada. The mark indicates that the product has been tested to meet the safety standards of both countries.

The embodiments described herein were chosen and described in order to best explain the principles of the invention and the practical application, and to enable others of ordinary skill in the art to understand the invention for various embodiments.

1. A mounting bracket comprising:
a rigid frame including outer periphery, a front side, and a rear side;
an opening in said frame, said opening includes a center;
a first flange extending outward from the outer periphery of the frame; and
a second flange extending rearward from the rear side of the frame around at least a portion of the inner periphery of the frame.

2. The mounting bracket of claim 1, comprising:
one or more frame arms integral with and extending from the rear side of the of the frame; and
a frame extension extending inwardly from the frame.

3. The mounting bracket of claim 2, comprising:
one or more apertures in said frame extension; and
a captive mounting screw positioned in each of said apertures in the frame extension.

4. The mounting bracket of claim 3, comprising wings and tabs on the ends of the captive mounting screws.

5. The mounting bracket of claim 4, comprising threaded screw holes in said frame extension.

6. The mounting bracket of claim 1, comprising said frame is die-cast in one piece of zinc alloy.

7. The mounting bracket of claim 1, comprising:
the first flange is at least 0.045 inch in thickness; and
the second flange includes a thickness of at least 0.075 inch.

8. The mounting bracket of claim 1, comprising the first flange and the second flange are perpendicular to one another.

9. The mounting bracket of claim 1, comprising:
said outer periphery of said frame includes V-shaped notches; and
said V-shaped notches are aligned with the center of the opening.

10. The mounting bracket of claim 1, comprising:
said frame includes corners; and
U-shaped notches positioned near the corners of the frame and defining end portions thereon.

11. The mounting bracket of claim 1, comprising:
a spacer including a body; and
a pair of posts extending from the body.

12. The mounting bracket of claim 11, comprising a bore and an end cap on each of said posts.

13. The mounting bracket of claim 12, comprising:
one or more slots at the edge of the opening;
said slots extending through a portion of the first flange and the second flange;
the slots are configured to accept insertion of the post of the spacer.

14. The mounting bracket of claim 1, comprising the front side of the frame is planar.
